(19) United States
(12) Patent Application Publication
(10) Pub. No.: US 2012/0092327 A1
(43) Pub. Date: Apr. 19, 2012

(54) OVERLAYING GRAPHICAL ASSETS ONTO VIEWING PLANE OF 3D GLASSES PER METADATA ACCOMPANYING 3D IMAGE

(75) Inventor: Suranjit Adhikari, San Diego, CA (US)

(73) Assignee: SONY CORPORATION

(21) Appl. No.: 12/904,326

(22) Filed: Oct. 14, 2010

(51) Int. Cl. G06T 15/00

(52) U.S. Cl. 345/419

(57) ABSTRACT

Responsive to metadata sent with 3D signals from an audio video display device, 3D glasses overlay graphical assets onto the 3D visual plane.

### I. FIELD OF THE INVENTION

The present application relates generally to overlaying graphical assets onto the viewing plane of three dimensional (3D) glasses according to metadata received with the 3D images.

### II. BACKGROUND OF THE INVENTION

Stereoscopy creates an illusion of depth in an image and provides the viewer with three-dimensional visual information. The list of methodologies that enable a two-dimensional image to be perceived as three-dimensional is extensive. One popular method is the anachrome compatible color anaglyph method, which implements optical diopter glasses with one red lens and one blue lens. The majority of techniques are based on the design of a two-dimensional image, such as the technique of adding shadows to a painting. 3D rendering typically relies on one or more of several cues the human eye and brain use to determine depth in a perceived scene.

As understood herein, it would be advantageous to augment 3D rendering to depict objects that may not be present in the video stream itself.

### SUMMARY OF THE INVENTION

Specifically, present principles relate to augmenting the stereoscopic viewing experience by seamlessly overlaying graphical objects onto the 3D video plane presented by 3D glasses. Accordingly, three dimensional (3D) glasses contain a user-wearable frame that supports a processor and left and right lenses for producing a simulated 3D image of video content presented on an audio video display device (AVDD) being viewed by a person wearing the glasses. The processor, responsive to metadata exchanged via an out of band transceiver which accompanies the video content, overlays onto simulated 3D images produced by the lenses at least one graphical object identified by the metadata.

The glasses processor presents the graphical object, or asset at a positional, or temporal, location in a received video stream. The positional or temporal location is defined by the metadata. The graphical assets can be visually represented in some but not all frames to remain substantially imperceptible to the viewer. The processor may also cause the graphical object to interact with at least one object in the content in accordance with the metadata. The AVDD can correlate the metadata to graphical object overlay commands received by the processor.

In another aspect, a method includes receiving 3D video content from a display of an audio video display device (AVDD), and presenting the 3D content on a 3D visual plane established by user-wearable 3D glasses. Responsive to metadata associated with the 3D content, graphical assets are overlaid onto the 3D visual plane.

In another aspect, a system includes and audio video display device (AVDD) presenting video content, and 3D glasses wearable by a person to view the video content on the AVDD and present a simulated 3D image thereof. The glasses overlay a graphical object onto the 3D image in accordance with metadata accompanying the video content.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing interior components of the 3d glasses and audio-video display device;

FIG. 2 is a schematic diagram illustrating a graphical asset as specified in metadata overlaid onto the viewing plane of 3D glasses; and

FIG. 3 is a flow chart of example logic in accordance with present principles.

### DETAILED DESCRIPTION OF THE PREFERRED EMBODIMENT

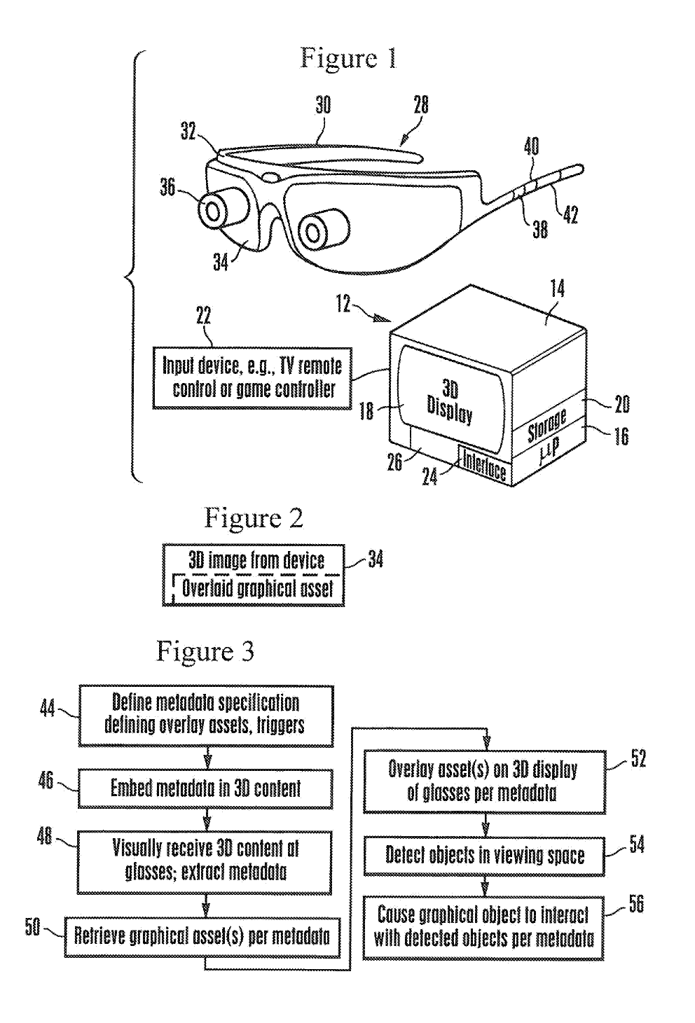

Referring initially to FIG. 1, an audio video device 12 such as a game console, TV, personal digital assistant, laptop computer, personal computer (PC), etc. includes a housing 14 bearing a digital processor 16. The processor 16 can control a visual display 18 to present 3D video and an audible display such as one or more speakers. The processor 16 may access a media player module such that the device 12 has media decoding capability.

To undertake present principles, the processor 16 may access one or more computer readable storage media 20 such as but not limited to RAM-based storage, a chip implementing dynamic random access memory (DRAM)) or flash memory or disk storage. Software code implementing present logic executable by the device 12 may be stored on one of the memories shown to undertake present principles.

The processor 16 can receive user input signals from various input devices 22 such as a TV remote commander (RC), game console controller, etc. A network interface 24 such as a wired or wireless modem or wireless telephony transceiver may also be provided and may communicate with the processor 16 so that the processor 16 can access the Internet via wired or wireless communication. A sideband transceiver 26 such as Bluetooth or IR, or other appropriate side channel may also be fixed in the housing 14.

A viewer can view 3D content presented on the display 18 by donning 3D glasses 28 which in the embodiment shown may have a frame with opposed temple pieces 30 configured for fitting onto a user's head over the ears. The frame may also have left and right frame rims 32 holding respective left and right 3D lenses 34. Also, respective left and right 3D cameras 36 may be provided on the lenses 34 to generate the below-described overlays onto the viewing plane of the glasses 28. Presentation of images on the lenses 34 may be controlled by a glasses microprocessor 38 accessing one or more disk-based or solid state storage media 40 in accordance with logic below. The media 40 may store executable instructions as well as graphical assets in accordance with present principles. In one example the glasses 28 may be physically embodied by Sony 3D glasses, Vuzix 3D glasses, etc. modified to execute present logic herein.

An out of band glasses transceiver 42 may be attached to the glasses 28 and be hard-wire connected to the glasses microprocessor 38. Communication in the form of metadata may be sent from the transceiver 26 on the display device 12 to the glasses transceiver 42. Again, the transceivers 26 and 42 may use an out-of-video-band, e.g., using Bluetooth or IR, and may not interfere with the viewing experience.

FIG. 2 is a presentation of an image on the lenses 34 that includes a three-dimensional image from a device along with an overlaid graphical asset. This simplified example of an asset overlaid on a three-dimensional image illustrates the addition of an asset whose display originates in the glasses 28 as directed by the glasses microprocessor 38 to a perceived image displayed on a separate display device 12.

Moving in reference to FIG. 3, example logic begins at block 44, where metadata specification is defined, further establishing the desired overlay assets and triggers. The metadata is then sent substantially simultaneously with the three-dimensional content at block 46 and received and extracted, or decoded, by the glasses microprocessor 38 at block 48. The graphical assets are retrieved from the storage media 40 as directed by the metadata within block 50 prior to being overlaid on the three-dimensional display lenses 34 of the glasses 28, also as directed by the metadata, at block 52. The objects are then presented in the graphics plane of the glasses, overlaid onto the video plane. Specific objects are detected in the viewing space at block 54 with the use of the cameras 36 and the graphical assets interact with the detected objects per metadata at block 56.

A portion of an example metadata specification is given in the table below for illustration:

| Graphical | Positional | Temporal | Interacting | Tagging |
|---|---|---|---|---|
| Asset | metadata | metadata | metadata | metadata |
| A—funny | Present | Present | Cause | Object in |
| face | accompanying | accompanying | accompanying | this frame |
| | asset type in the | asset type for | asset type to | is soft |
| | lower left of the | frames 2000- | appear to flee | |
| | presentation | 5000 of the | any object | |
| | | presentation | moving toward | |
| | | | it | |
| B—jet | Present | Present | Cause | Object in |
| plane | accompanying | accompanying | accompanying | this frame |
| | asset type in the | asset type for | asset type to | is hard |
| | middle of the | frames 5000- | appear to ram | |
| | presentation | 8000 of the | “soft” objects | |
| | | presentation | moving toward | |
| | | | it | |

In some implementations, the metadata accompanying the video is correlated by the glasses to graphical assets and their positioning in being overlaid on the video. In other implementations the audio video display device (AVDD) correlates the metadata to graphical assets and then signals to the glasses what the assets are, when and where they should be overlaid on the video, and what their interactions should be with objects in the video.

In some implementations, instead of sending the metadata out-of-band, the metadata can be embedded as, e.g., bar codes in the video itself and may be presented for only a frame or two of video, e.g., for only one frame out of thirty, so that the metadata is not perceptible to a viewer but can be sensed and decoded by the glasses when the viewer is looking at the display of the AVDD. Alternatively, as discussed above the AVDD can receive metadata in packets along with video packets in the stream and then relay the metadata to the glasses out-of-video-band, e.g., using Bluetooth or IR signaling by means of the out-of-band transceivers.

While the particular OVERLAYING GRAPHICAL ASSETS ONTO VIEWING PLANE OF 3D GLASSES PER METADATA ACCOMPANYING 3D IMAGE is herein shown and described in detail, it is to be understood that the subject matter which is encompassed by the present invention is limited only by the claims.

What is claimed is:

1. Three dimensional (3D) glasses comprising:
a user-wearable frame;
a processor supported on the frame;
left and right lenses supported by the frame for producing a simulated 3D image of video content presented on an audio video display device (AVDD) being viewed by a person wearing the glasses;
the processor, responsive to metadata received substantially simultaneously with the video content, overlaying onto simulated 3D images produced by the lenses at least one graphical object, the graphical object being identified by the metadata.

2. The 3D glasses of claim 1, wherein the processor presents the graphical object at a temporal location in a received video stream, the temporal location being defined by the metadata.

3. The 3D glasses of claim 1, wherein the processor presents the graphical object at a positional location in a received video stream, the positional location being defined by the metadata.

4. The 3D glasses of claim 1, wherein the processor causes the graphical object to interact with at least one object in the content in accordance with the metadata.

5. The 3D glasses of claim 1, wherein the AVDD correlates the metadata to graphical object overlay commands, the processor receiving the overlay commands.

6. The 3D glasses of claim 1, wherein the processor correlates the metadata to graphical object overlay commands

7. The 3D glasses of claim 1, wherein the metadata is visually represented in only some but not all frames of the video content to remain substantially imperceptible to a viewer of the video content.

8. The 3D glasses of claim 1, wherein the processor receives the metadata from the AVDD over a link that is out of band with visible presentation of the video content.

9. Method comprising:
receiving 3D video content from a display of an audio video display device (AVDD);
presenting the 3D content on a 3D visual plane established by user-wearable 3D glasses; and
responsive to metadata associated with the 3D content, overlaying graphical assets onto the 3D visual plane.

10. The method of claim 9, comprising presenting a graphical object at a temporal location in a video stream received at the glasses, the temporal location being defined by the metadata.

11. The method of claim 9, comprising presenting a graphical object at a positional location in a video stream received at the glasses, the positional location being defined by the metadata.

12. The method of claim 9, comprising causing a graphical object to interact with at least one object in the content in accordance with the metadata.

13. The method of claim 9, comprising using the AVDD to correlate the metadata to graphical object overlay commands and send the commands to the glasses.

14. The method of claim 9, comprising using the glasses to correlate the metadata to graphical object overlay commands.

15. The method of claim 9, comprising visually representing the metadata in only some but not all frames of video content to remain substantially imperceptible to a viewer of the video content.

16. The method of claim 9, comprising receiving, at the glasses, the metadata from the AVDD over a link that is out of band with visible presentation of video content.

17. System comprising:
audio video display device (AVDD) presenting video content; and
3D glasses wearable by a person to view the video content on the AVDD and present a simulated 3D image thereof, the glasses overlaying a graphical object onto the 3D image in accordance with metadata accompanying the video content.

18. The system of claim 17, wherein the AVDD correlates the metadata to graphical object overlay commands, the glasses receiving the overlay commands.

19. The system of claim 17, wherein the glasses correlates the metadata to graphical object overlay commands

20. The system of claim 17, wherein the metadata is visually represented in only some but not all frames of the video content to remain substantially imperceptible to a viewer of the video content.
